(19) United States
(12) Patent Application Publication
(10) Pub. No.: US 2017/0059306 A1
(43) Pub. Date: Mar. 2, 2017

(54) POINT CLOUD SYSTEMS AND METHODS

(71) Applicant: SMART MULTIMEDIA, INC., Houston, TX (US)

(72) Inventor: Richard L. Lasater, Anahuac, TX (US)

(21) Appl. No.: 15/353,469

(22) Filed: Nov. 16, 2016

Related U.S. Application Data
(63) Continuation of application No. PCT/US2015/032049, filed on May 21, 2015.
(60) Provisional application No. 62/001,401, filed on May 21, 2014.
(60) Provisional application No. 62/001,469, filed on May 21, 2014.

(51) Int. Cl. G01B 11/24; H04N 7/18; G06F 17/30; G06T 7/00

(52) U.S. Cl. CPC G01B 11/24; G06T 7/004; H04N 7/183; G06F 17/30312; G06F 17/3028; G06T 2207/10028; G06T 2207/10024

(57) ABSTRACT

A system and method for generating a database representative of a physical structure having a plurality of components may include a computer, a memory in communication with the computer, and a laser scanner in communication with the computer. The laser scanner may be configured to capture spatial data representative of points on the structure, wherein each of the points is part of one of the plurality of components. The computer may be programmed with instructions executable by the computer for receiving the spatial data, storing the spatial data in a database in the memory, receiving non-spatial data representative of each of the plurality of components, and, for each of the points, associating a portion of the non-spatial data with each respective point in the database based on a respective one of the plurality of components of which each respective point is a part. The data may include color data.

### CROSS REFERENCE TO RELATED APPLICATIONS

This application claims priority to U.S. Provisional Patent Application No. 62/001,469 filed May 21, 2014, and U.S. Provisional Patent Application No. 62/001,401 filed May 21, 2014. The disclosure of each of the foregoing applications is incorporated herein by reference.

### FIELD

This application relates generally to the field of creating electronic databases and images representative of physical structures.

### BACKGROUND

Laser scanners are frequently used to create electronic images of various existing structures, such as buildings, industrial facilities, ships, and the like. Such scanners are capable of creating very precise digital images that may be used for a variety of purposes, such as computer modeling, maintenance, repair, and the like. One challenge in the field is that the data initially produced by such scanners is merely a collection of unrelated points; that is, each point is merely identified by a set of coordinates (such as cartesian coordinates (X, Y, Z), for example), and the points are not grouped into objects. Although some computer software tools are available for manipulating the initial point data to form various objects, the process of converting raw point data into a computer model of a scanned structure is generally very labor intensive, time consuming, and expensive. Such computer modeling software may be used for generating rich data models of a structure that contain a wide variety of information about the various components in the model. For example, a model database for a particular component may indicate not only the component's geometry but also its material, purchase date, vendor, service data, and the like. However, the raw point data captured by a scanner generally does not have any such additional data associated with the various points. It would be a significant advancement in the art to provide systems and methods that allow efficient generation of rich databases for scanned structures without the need for modeling all of the various components of the structures.

Some laser scanners may have a camera that is integral with or attached to the laser scanner for the purpose of taking digital photographs of the objects being scanned. However, a challenge exists as to the proper correlation of the data generated by the laser scanner and the data generated by the camera. In particular, although the laser scanner generates three-dimensional spatial data for each point that it scans, the camera simply generates two-dimensional data of whatever is within its field of view (i.e., the camera simply portrays x-y data without any depth association). Additionally, to the extent the laser scanner and the camera have different nodal locations, they will produce data from different perspectives, thereby introducing challenges associated with parallax error. In order to overcome the challenges associated with parallax error, the acquisition of laser scan data and color data (e.g., RGB data) generally must be done at two separate times or steps, usually requiring an equipment change. Furthermore, for mobile “profiling” 3D scanners, for example, it is extremely difficult if not impossible to recreate the exact conditions to complete the second step, so mobile data is generally collected without color data or with parallax errors. Thus, it is a challenge to associate the proper color for each point that is captured by the scanner. It would be a significant advancement in the art to provide a laser scanner and camera system that accurately associates the data from the digital camera with the data from the laser scanner and to be able to collect color data (e.g., RGB data) and 3D scan data at the same or substantially the same time.

### SUMMARY

A system and method for generating a database representative of a physical structure having a plurality of components may include a computer, a memory in communication with the computer, and a laser scanner in communication with the computer. The laser scanner may be configured to capture spatial data representative of points on the structure, wherein each of the points is part of one of the plurality of components. The computer may be programmed with instructions executable by the computer for receiving the spatial data, storing the spatial data in a database in the memory, receiving non-spatial data representative of each of the plurality of components, and, for each of the points, associating a portion of the non-spatial data with each respective point in the database based on a respective one of the plurality of components of which each respective point is a part.

In some embodiments, the associating of the appropriate non-spatial data with the respective points may be performed without creating a model of the plurality of components.

In some embodiments, the points that make up each respective component may be compressed using a data compression scheme wherein a bounding box is used to delineate the points that make up the respective component, and the points that make up the respective component may be defined on a row-by-row and layer-by-layer basis within the bounding box with binary data, wherein a 1 indicates the presence of a physical point of the respective component at a given location in space and a 0 indicates the absence of a physical point at a given location in space.

A system for capturing spatial and color data for an object may include a computer in communication with a memory, a laser scanner, and a digital camera. The laser scanner may be configured to capture spatial data representative of points on the object, and the camera may be configured to capture color data representative of those points. The computer may be programmed with instructions for associating the color data with the spatial data for each of the points and storing the associated data in a database in the memory. In some embodiments, a display in communication with the computer may be configured for displaying an image representative of the object.

In some embodiments, each of the laser scanner and the camera may be configured such that its central line of sight extending from a respective node thereof is aligned with a point H defined by a maximum effective range Rₘₐₓ of the laser scanner. The computer may include instructions for performing the following actions with respect to each of the points: receiving from the laser scanner information representative of a distance from the node of the laser scanner to the respective point; receiving from the camera information representative of color of a plurality of points on the object, the plurality of points including the respective point; calculating a distance d from the central line of sight of the camera to an image of the respective point within a camera image on an image plane of the camera; identifying a pixel within the camera image located at or near the distance d from the central line of sight of the camera as corresponding to the respective point; and associating color information of the pixel with the respective point in the database.

In some embodiments, a method of generating a database of spatial and non-spatial data for a plurality of points representative of a physical structure may include receiving at a computer spatial data representative of points on a physical structure, wherein the physical structure includes a plurality of components; storing the spatial data in a database in a memory in communication with the computer; receiving at the computer non-spatial data representative of each of the plurality of components; and for each of the points, associating a portion of the non-spatial data with each respective point in the database based on a respective one of the plurality of components of which each respective point is a part.

In some embodiments, an article of manufacture may include a tangible computer readable medium including a program having instructions executable by a computer for: receiving at a computer spatial data representative of points on a physical structure, wherein the physical structure includes a plurality of components; storing the spatial data in a database in a memory in communication with the computer; receiving at the computer non-spatial data representative of each of the plurality of components; and for each of the points, associating a portion of the non-spatial data with each respective point in the database based on a respective one of the plurality of components of which each respective point is a part.

### BRIEF DESCRIPTION OF THE DRAWINGS

Examples of point cloud systems and methods are shown in the accompanying drawings in which:

FIG. 1 is a schematic diagram of a laser scanning system.

FIG. 2 is a perspective view of a sample structure that may be scanned.

FIG. 3 is a schematic diagram of a component of the structure of FIG. 2 and a bounding box for such component.

FIG. 4 is a schematic diagram of a sample data format.

FIG. 5 is a plan view schematic diagram of a laser scanner and camera configured to capture a target point on an object.

FIG. 6 is a plan view schematic diagram of the target point and camera of FIG. 5.

FIG. 7 is a perspective view of a laser scanner and camera configured to capture a target point on a building.

FIG. 8 is a plan view of another sample structure.

FIG. 9 is a flowchart illustrating a data acquisition and manipulation process.

FIG. 10 is a schematic diagram of the structure of FIG. 8 with a plurality of bounding boxes.

FIG. 11 is a schematic diagram of a bounding box in a first orientation.

FIG. 12 is a schematic diagram illustrating a translation of the bounding box of FIG. 11.

FIG. 13 is a schematic diagram illustrating a rotation of the bounding box of FIG. 11.

FIG. 14 is a schematic diagram of another sample data format.

### DETAILED DESCRIPTION

The following terms as used herein should be understood to have the indicated meanings unless the context requires otherwise.

When an item is introduced by “a” or “an,” it should be understood to mean one or more of that item.

“Communication” means the transmission of one or more signals from one point to another point. Communication between two objects may be direct, or it may be indirect through one or more intermediate objects. Communication in and among computers, I/O devices and network devices may be accomplished using a variety of protocols. Protocols may include, for example, signaling, error detection and correction, data formatting and address mapping. For example, protocols may be provided according to the seven-layer Open Systems Interconnection model (OSI model), the TCP/IP model, or any other suitable model.

“Comprises” means includes but is not limited to.

“Comprising” means including but not limited to.

“Computer” means any programmable machine capable of executing machine-readable instructions. A computer may include but is not limited to a general purpose computer, mainframe computer, microprocessor, computer server, digital signal processor, personal computer (PC), personal digital assistant (PDA), laptop computer, desktop computer, notebook computer, smartphone (such as Apple's iPhone™, Motorola's Atrix™ 4G, and Research In Motion's Blackberry™ devices, for example), tablet computer, netbook computer, portable computer, portable media player with network communication capabilities (such as Microsoft's Zune HD™ and Apple's iPod Touch™ devices, for example), camera with network communication capability, wearable computer, point of sale device, or a combination thereof. A computer may comprise one or more processors, which may comprise part of a single machine or multiple machines.

“Computer readable medium” means an article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, or combination thereof.

“GUI” means graphical user interface.

“Having” means including but not limited to.

“Interface” means a portion of a computer processing system that serves as a point of interaction between or among two or more other components. An interface may be embodied in hardware, software, firmware, or a combination thereof.

“I/O device” may comprise any hardware that can be used to provide information to and/or receive information from a computer. Exemplary I/O devices may include disk drives, keyboards, video display screens, mouse pointers, joysticks, trackballs, printers, card readers, scanners (such as barcode, fingerprint, iris, QR code, and other types of scanners), RFID devices, tape drives, touch screens, cameras, movement sensors, network cards, storage devices, microphones, audio speakers, styli and transducers, and associated interfaces and drivers.

“Memory” may comprise any computer readable medium in which information can be temporarily or permanently stored and retrieved. Examples of memory include various types of RAM and ROM, such as SRAM, DRAM, Z-RAM, flash, optical disks, magnetic tape, punch cards, EEPROM, and combinations thereof. Memory may be virtualized, and may be provided in or across one or more devices and/or geographic locations, such as RAID technology, for example.

“Model” means a computer representation of a physical object using equations to create lines, curves, and other shapes and to place those shapes accurately in relation to each other and to the two-dimensional or three-dimensional space in which they are drawn.

“Module” means a portion of a program.

“Program” may comprise any sequence of instructions, such as an algorithm, for example, whether in a form that can be executed by a computer (object code), in a form that can be read by humans (source code), or otherwise. A program may comprise or call one or more data structures and variables. A program may be embodied in hardware, software, firmware, or a combination thereof. A program may be created using any suitable programming language, such as C, C++, Java, Perl, PHP, Ruby, SQL, other languages, and combinations thereof. Computer software may comprise one or more programs and related data. Examples of computer software may include system software (such as operating system software, device drivers and utilities), middleware (such as web servers, data access software and enterprise messaging software), application software (such as databases, video games and media players), firmware (such as software installed on calculators, keyboards and mobile phones), and programming tools (such as debuggers, compilers and text editors).

“Signal” means a detectable physical phenomenon that is capable of conveying information. A signal may include but is not limited to an electrical signal, an electromagnetic signal, an optical signal, an acoustic signal, or a combination thereof.

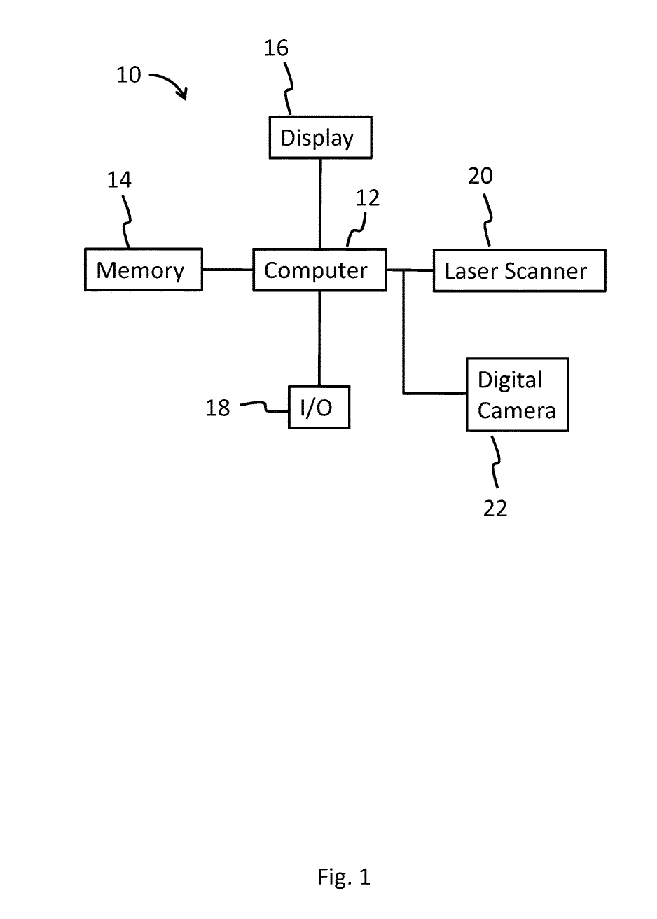

As shown in FIG. 1, a system 10 may include a computer 12 in communication with a memory 14, a display 16, an I/O device 18, a laser scanner 20, and a digital camera 22. Although only one computer, memory, display, I/O device, laser scanner, and digital camera are shown in FIG. 1, persons of ordinary skill in the art will understand that more than one of each of those items may be employed if desired. Computer 12 may be programmed with one or more programs to carry out the methods described herein. In some embodiments, laser scanner 20, camera 22, and computer 12 (as well as some or all of the other components, such as memory 14, display 16, and I/O device 18) may all be part of the same machine. In some embodiments, laser scanner 20 and camera 22 may be remote from computer 12. Some embodiments may not include a camera.

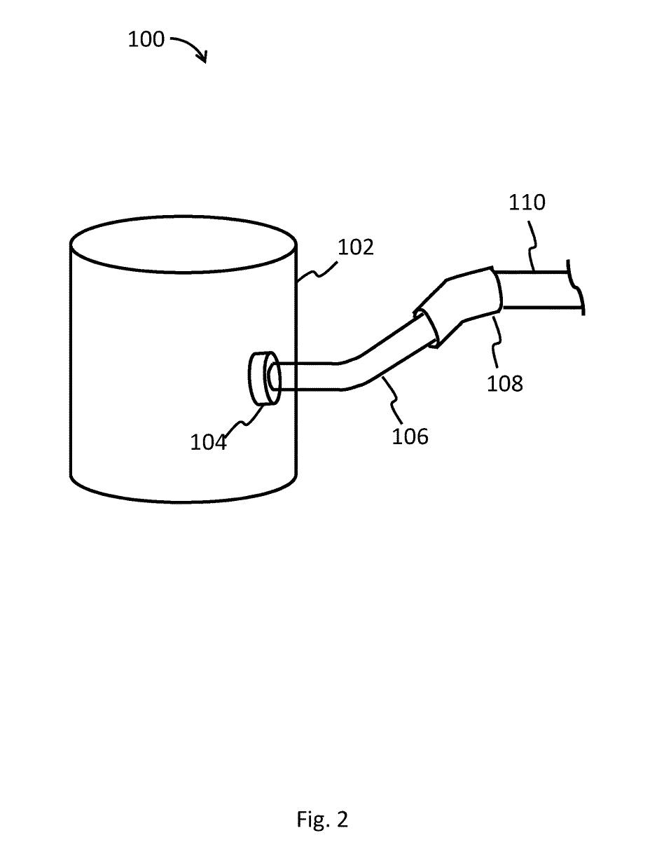

In some embodiments, laser scanner 20 and camera 22 may be configured in a fixed relationship to each other, either in a single integral machine or via attachment, for example. Laser scanner 20 may be a Leica Geosystems ScanStation P20™ laser scanner available from Smart Multimedia, Inc. (Houston, Tex.), or any other suitable line-of-sight, phase-based, or time-of-flight scanner, for example. Camera 22 may be a Canon Eos 5D™ camera available from Canon U.S.A., Inc. (Melville, N.Y.), for example. Of course, any suitable laser scanner and camera may be used. In conjunction with computer 12, laser scanner 20 and camera 22 may be configured to substantially simultaneously scan and photograph a structure, such as structure 100 in FIG. 2, for example, and thereby create an electronic database in memory 14 that is representative of both the geometry and the color characteristics of the structure, which may be rendered as an image on display 16, for example. In some embodiments, the electronic database may include data representative of each point of the structure that is scanned, and such data may include spatial coordinates, e.g., (x,y,z) cartesian coordinates, as well as color data, e.g., RGB color data, for each point. The spatial coordinates may be derived from the laser scanning measurements captured by laser scanner 20, and the color information may be captured by camera 22 and referenced to the appropriate point as described further below.

A system 10 as described above may be operated so as to generate a database of points representative of any physical structure, such as structure 100 shown in FIG. 2. In some embodiments, laser scanner 20 and camera 22 may be operated from multiple known geographic locations having different perspectives with respect to structure 100, and the spatial and color data collected from each such location may be combined via matching of common points in the various data sets or applying appropriate coordinate transformations, for example. In this manner, a geometrically and colorimetrically precise three-dimensional electronic representation of any physical structure may be created.

In the example of FIG. 2, structure 100 may be composed of a plurality of components, such as tank 102, fitting 104, tube 106, connector 108, and tube 110, for example. As a result of structure 100 being scanned and possibly photographed as described above, a database of raw point data may be generated in memory 14 that is representative of structure 100. Each point may be defined by spatial data, such as cartesian coordinates (X, Y, Z), for example, or other suitable spatial data (e.g., spherical coordinates). In some embodiments, the raw data may include other data such as an intensity value, one or more color values (e.g., RGB values), and/or point normal data, for example. After the raw point data is captured, a GUI or other suitable computer software tool may be used to segment the raw data into groups of data, wherein each group of points is representative of a particular component of structure 100. For instance, in the example of FIG. 2, the raw data may be segmented into a group of points representative of tank 102, a group of points representative of fitting 104, a group of points representative of tube 106, a group of points representative of connector 108, and a group of points representative of tube 110, for example. In some embodiments, each such group of points may be segregated into a separate file; alternatively, the various groups of points may be in the same file.

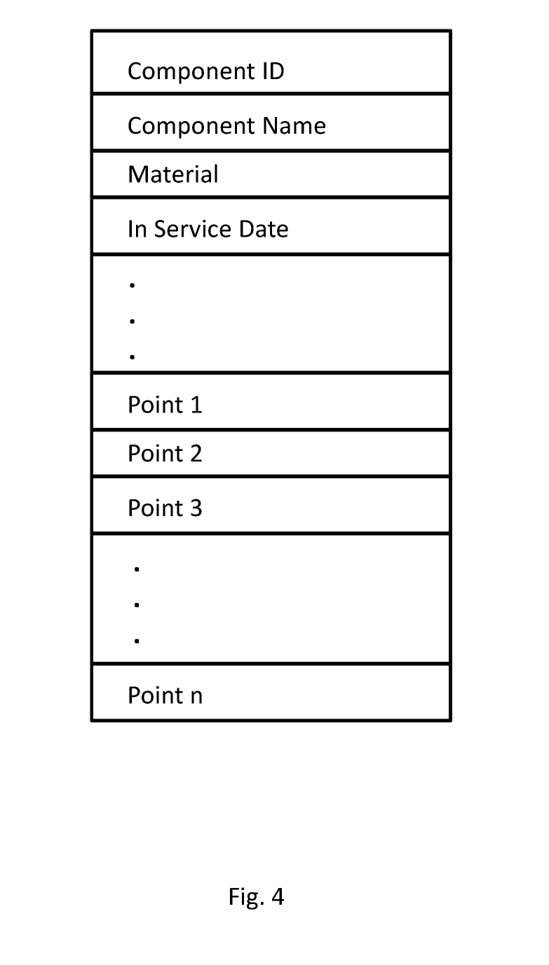

Once the points are segmented, a database entry may be generated for each component of structure 100, and additional (non-spatial) data may be associated with each point. For example, in some embodiments, a database entry for a given component may be formatted as shown in FIG. 4, and the points (1, 2, 3, . . . n) that are part of that component may be defined by a data compression scheme as described further below. Of course, any suitable data format may be used, with the primary concept being the association of non-spatial data (sometimes referred to herein as meta data) with each of the points in the database. For example, points on tank 102 may be associated with non-spatial data representative of the volume of the tank, the height of the tank, the diameter of the tank, the wall thickness of the tank, the material of which the tank is made, the date on which the tank was placed in service, the next maintenance due for the tank, the other components to which the tank is connected, or any other data that may be relevant to the tank. Similarly, other non-spatial data may be associated with the other components of structure 100.

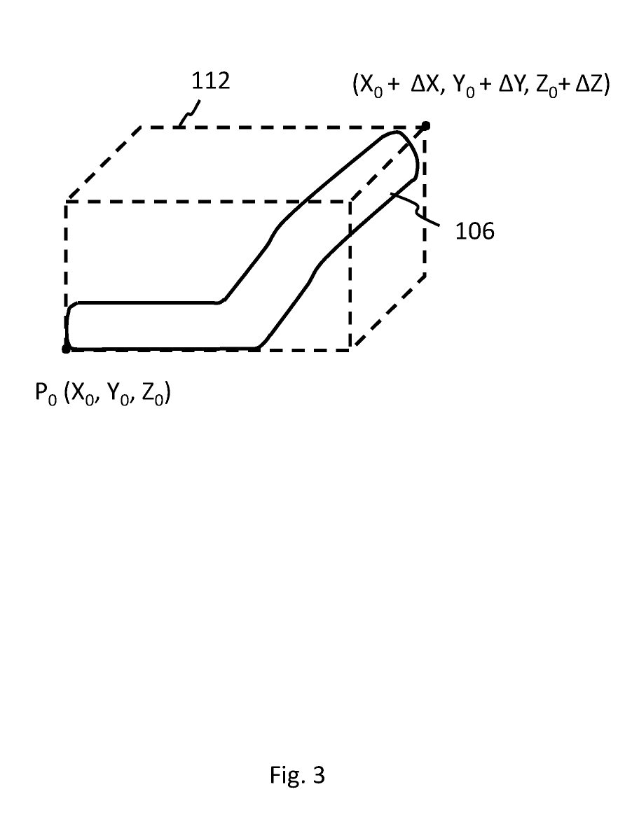

In some embodiments, such associations may be facilitated by a suitable data compression scheme. For example, as shown in FIG. 3, a bounding box may be used as part of a GUI or other suitable tool to delineate the points that make up a given component of structure 100. In the example of FIG. 3, a bounding box 112 is shown that is sufficient to enclose tube 106. Bounding box 112 may be defined by a vertex indicated at (X₀, Y₀, Z₀) and a width, height, and depth ΔX, ΔY, ΔZ, respectively, measured from that vertex, such that all of the points that make up tube 106 are located within bounding box 112. The points that make up tube 106 may be defined on a row-by-row and layer-by-layer basis within bounding box 112 with binary data (1's and 0's), wherein a 1 indicates the presence of a physical point of tube 106 at a given location in space and a 0 indicates the absence of a physical point at a location, for example. Similar data may be generated for the other components of structure 100. In this manner, the data representative of structure 100 may be significantly compressed as compared to storing (X, Y, Z) data for every point of the structure, which may significantly improve computational and storage efficiency and rendering times, and yet each point may be associated with a rich set of non-spatial data that may be readily accessed by a user without incurring the labor, time, and expense of creating a computer model of each component of the structure.

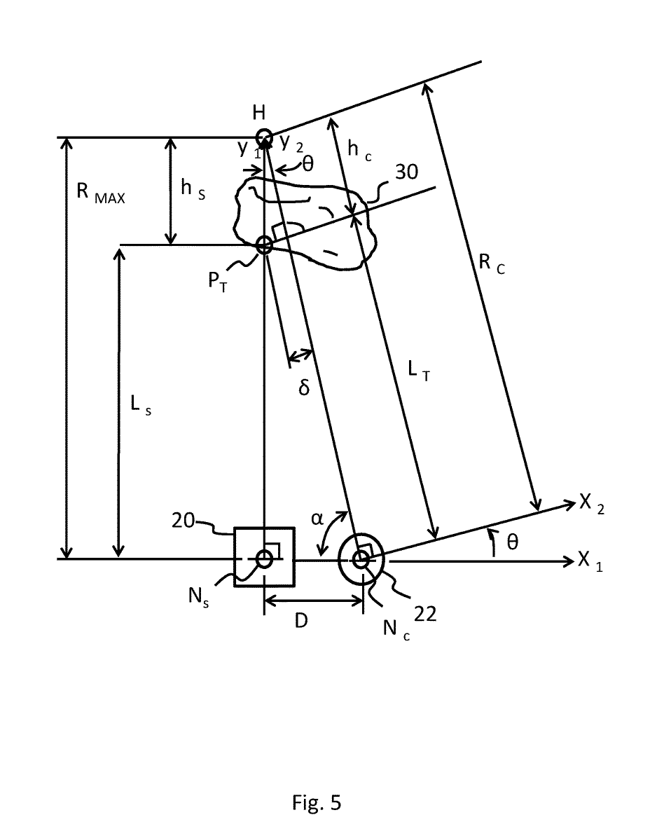

Referring to FIGS. 5 and 7, in some embodiments, the “nodes” of laser scanner 20 and camera 22 may be designated as N_{S} and N_{C}, respectively. In the general case illustrated in FIG. 7, laser scanner 20 and camera 22 may be located and oriented at any suitable location and orientation, with scanner node N_{S} at the origin of reference system (x₁, y₁, z₁) and camera node N_{C} at the origin of reference system (x₂, y₂, z₂), for example. As persons of ordinary skill in the art will appreciate, since the location and orientation of both reference systems are known, any given point in one system may be referenced to the other system via a coordinate transformation calculation. In some embodiments, as shown in FIG. 5, to simplify the calculations described further below, laser scanner 20 and camera 22 may be configured such that camera node N_{C} is located on the x₁ axis, and each of laser scanner 20 and camera 22 may be configured such that its central line of sight (e.g., y₁ or y_{z} axis) extending from node N_{S} or N_{C}, respectively, is aligned with a “horizon” point H defined by the maximum effective range Rₘₐₓ of laser scanner 20, which is a known quantity. In the example shown in FIG. 5, N_{S} and N_{C} are separated by a known distance D, and reference system (x₂, y₂, z₂) is rotated about its z₂ axis such that axis x₂ is oriented at an angle θ with respect to axis x₁.

Still referring to FIG. 5, the distance L_{S} from scanner node N_{S} to a target point P_{T} on object 30 may be measured by laser scanner 20. The distance hₛ from point P_{T} to point H may be calculated according to the equation

hₛ=Rₘₐₓ−L_{S}

The perpendicular distance 6 from axis y₂ to point P_{T} may be calculated according to the equation

δ=hₛ sin θ

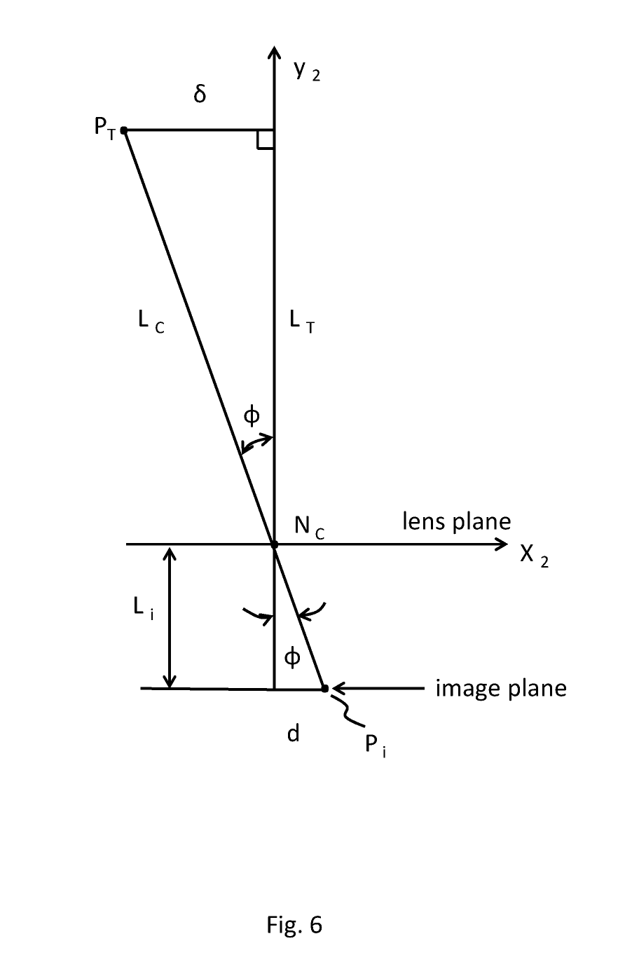

Referring now to FIG. 6 in conjunction with FIG. 5, the point Pᵢ in the image captured by camera 22 corresponds to point P_{T} on object 30. The image plane of camera 22 is located a known distance Lᵢ from the lens plane (center of lens, axis x₂). It is desired to determine the distance d from axis y₂ to point Pᵢ in order to identify the appropriate pixel in the image (and thus the appropriate color information) that is to be associated with point P_{T}. To that end, the distance R_{C} may be calculated according to the equation

R_{C}=D/sin θ

The distance h_{c} may be calculated according to the equation

h_{c}=δ/tan θ

The distance L_{T} may then be calculated according to the equation

L_{T}=R_{C}−h_{c}

The angle φ between the y₂ axis and the line between point P_{T} and point Pᵢ (which passes through node N_{C}) is related to the above distances according to the equation

tan φ=δ/L_{T}=d/Lᵢ

Based on that, the distance d may then be calculated according to the equation

d=δLᵢ/L_{T}

The appropriate pixel located a distance d from the center of the camera image may then be identified as corresponding to point P_{T}, and thus the color information (e.g., RGB color data) associated with that pixel may be associated with point P_{T} in the database. In some embodiments, depending on the relative resolutions of the laser scanner data and the camera image data, the scanner and camera and computer processing speeds, or other factors, for example, it may be desirable to select a pixel that is closest to the distance d, or perform one or more interpolations or other data smoothing operations in order to more effectively define the electronic database to be representative of the color of scanned object 30 at each scanned point. Additionally, depending on the particular lens or lenses involved in camera 22, one or more additional or different calculations may need to be performed in order to determine the appropriate image pixel and its color information to be associated with each scanned point P_{T}. For example, different degrees of refraction and/or distance distortion for the particular lens or lenses of camera 22 may be taken into account. In any event, persons of ordinary skill in the art will appreciate that system 10 may be operated as described herein so as to capture the spatial coordinates and associated color of each desired point on object 30. For example, referring again to FIG. 7, laser scanner 20 and camera 22 may be rotated about axes x₁ and z₁, as indicated at rₓ and r_{z}, respectively, at known incremental angles in order to capture spatial and color data for as many points P_{T} as may be desired. In some embodiments, laser scanner 20 and camera 22 may be operated from multiple known geographic locations having different perspectives with respect to object 30, and the spatial and color data collected from each such location may be combined via matching of common points in the various data sets or applying appropriate coordinate transformations, for example. In this manner, a geometrically and colorimetrically precise three-dimensional electronic representation of any object 30 may be created, which may be utilized for many beneficial purposes, such as computer modeling, asset visualization, maintenance, repair, and the like.

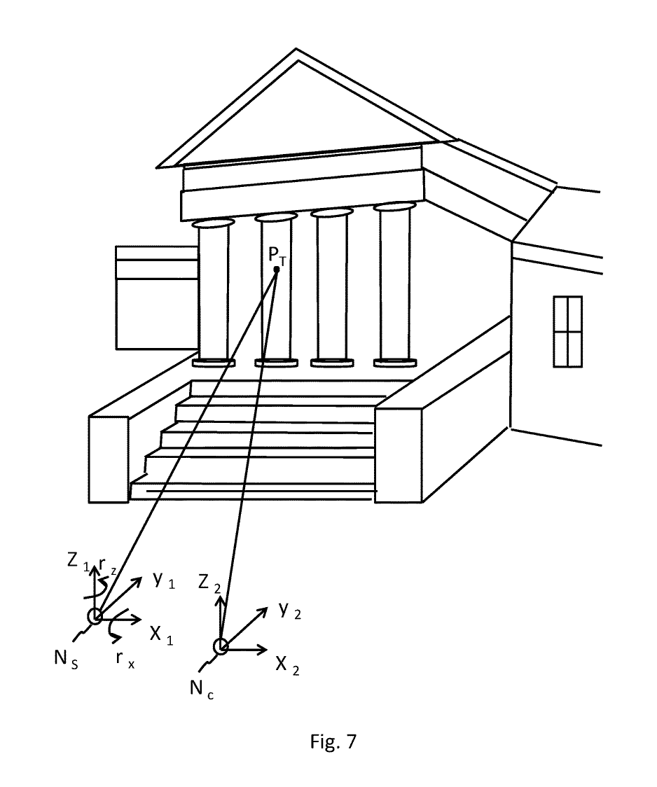

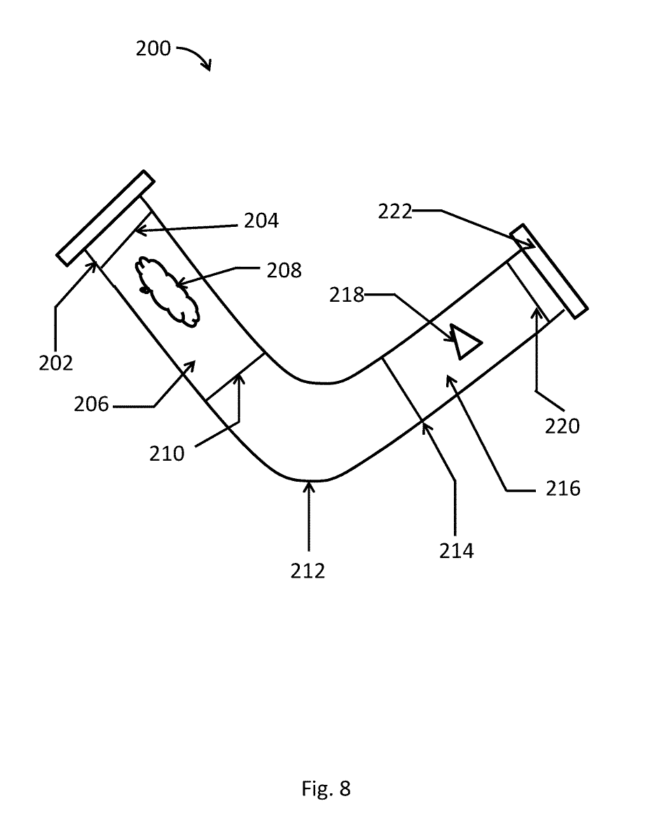

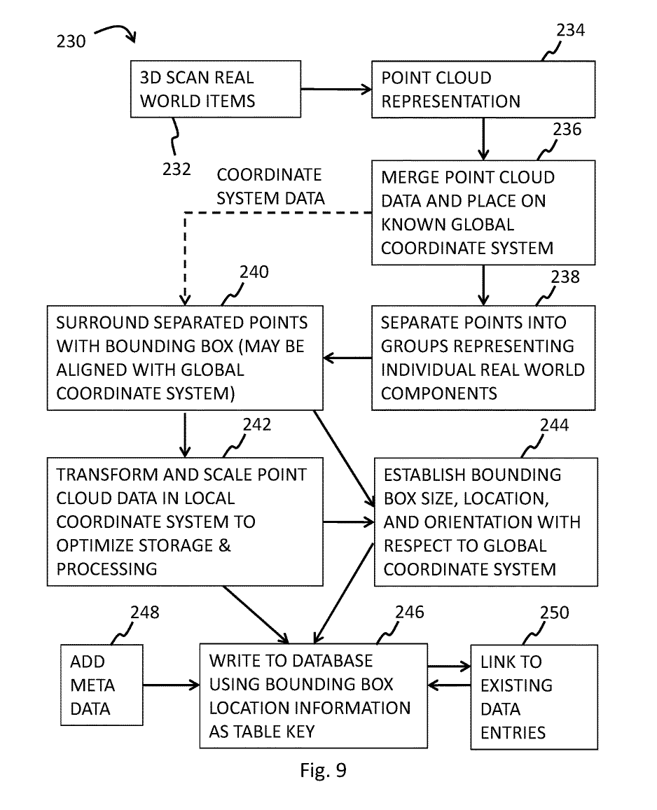

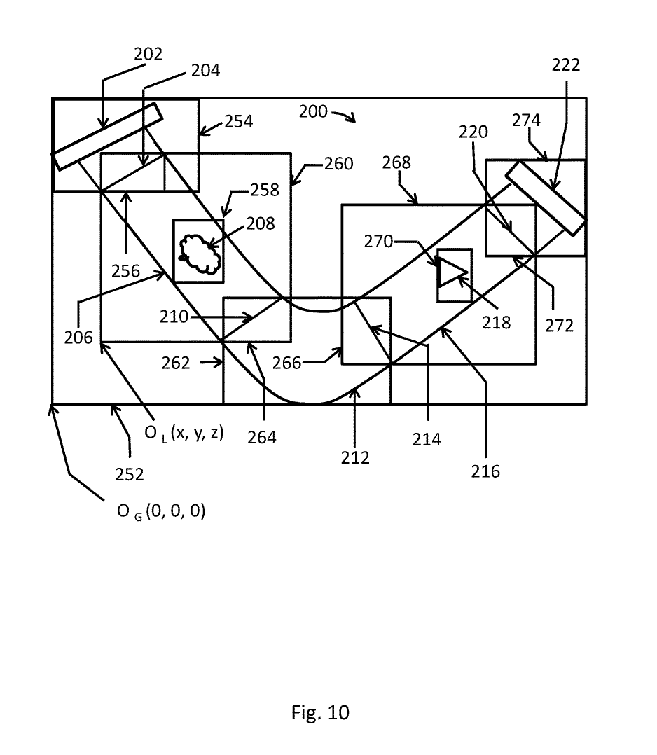

In some embodiments, the points of a scanned structure may be segmented into a plurality of groups, each of which is representative of a particular component of the overall structure. The spatial data for each group of points (e.g., each component) may be transformed from a global coordinate system having an origin O_{G} (which may be arbitrary and not necessarily global in a literal sense) into a local coordinate system having an origin O_{L} (see, e.g., FIGS. 10-13) and may be normalized in order to make the processing and storage of such data more efficient. For example, as shown in FIG. 8, a structure 200 may be composed of several components (sometimes referred to herein as assets), such as a flange 202, a weld joint 204, a pipe 206, an area of corrosion 208, a weld joint 210, a pipe elbow 212, a weld joint 214, a pipe 216, a defect 218, a weld joint 220, and a flange 222. As indicated at 232 of method 230 shown in FIG. 9, structure 200 may be scanned using a system 10 as described above, yielding a point cloud representation of structure 200 as indicated at 234. If multiple scans of structure 200 are performed, the point data from the several scans may be merged and placed in a known global coordinate system as indicated at 236. The points may be segmented or separated into groups, each of which is representative of a component of structure 200 as indicated at 238. Each component may be bounded by a bounding box as indicated at 240. For example, as illustrated in FIG. 10, flange 202 may be contained within bounding box 254, weld joint 204 may be contained within bounding box 256, pipe 206 may be contained within bounding box 260, area of corrosion 208 may be contained within bounding box 258, weld joint 210 may be contained within bounding box 264, pipe elbow 212 may be contained within bounding box 262, weld joint 214 may be contained within bounding box 266, pipe 216 may be contained within bounding box 268, defect 218 may be contained within bounding box 270, weld joint 220 may be contained within bounding box 272, and flange 222 may be contained within bounding box 274. All of such components may be contained within bounding box 252.

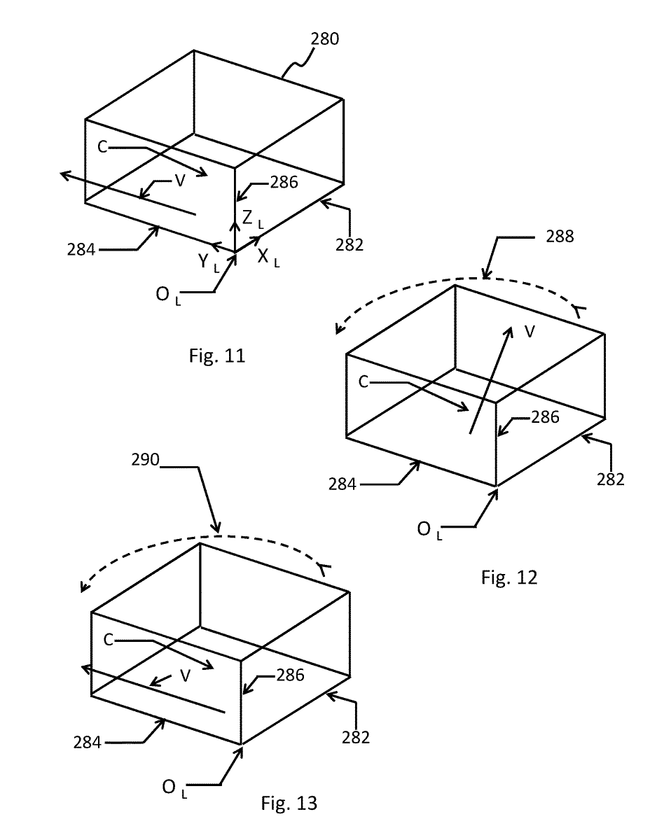

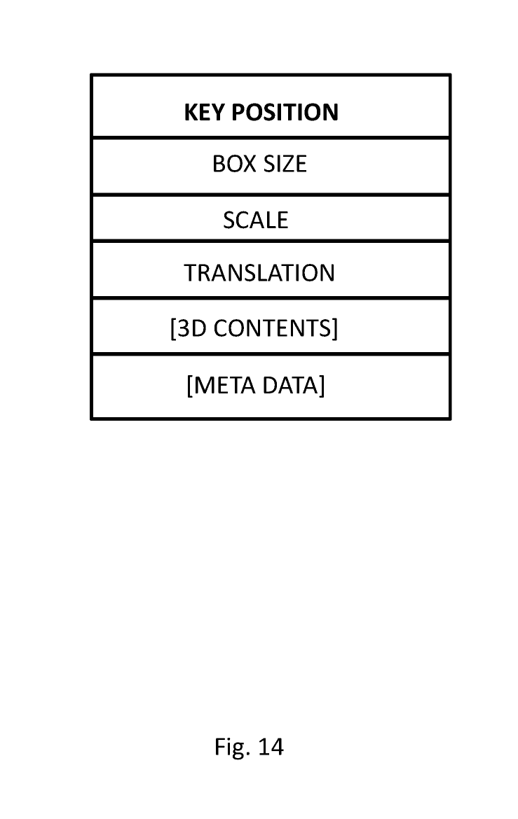

Referring again to FIG. 9, once the bounding boxes have been established for the various components, the spatial data for the points of each respective component may be transformed to a local coordinate system associated with each respective bounding box and normalized (scaled) to make the spatial data easier to store and process, as indicated at 242. For each bounding box, the size, location, and orientation of its local coordinate system with respect to the global coordinate system may be calculated, as indicated at 244, and used to transform the spatial data of the points within that bounding box from the global coordinate system into the local coordinate system of such bounding box. In general, each bounding box may be established however it may be convenient in order to contain all the points of the associated component, and the origin and axes of the local coordinate system of each bounding box may be related to the origin and axes of the global coordinate system by a three-dimensional translation (e.g., Δx, Δy, Δz) (represented by reference 288 in FIG. 12) and a three-dimensional rotation (e.g., Rₓ, R_{y}, R_{z}) (represented by reference 290 in FIG. 13). In some embodiments, such as shown in FIG. 10, for example, such coordinate transformations may be simplified by selection of bounding boxes that have the same orientation as the global coordinate system. In some embodiments, the global coordinate system may be established such that all points on the scanned structure have zero or positive x, y, and z values, and the origin O_{L} of the local coordinate system (x_{L}, y_{L}, z_{L}) of each bounding box may be established at the corner nearest the origin of the global coordinate system, as shown in FIG. 10 for bounding box 260. In such embodiments, as illustrated in FIG. 11 for a bounding box 280 having point contents C for a given component, edge 282 of bounding box 280 may be along the local x_{L} axis, edge 284 of bounding box 280 may be along the local y_{L} axis, and edge 286 of bounding box 280 may be along the local z_{L} axis. In this embodiment, vector V generally represents the orientation of bounding box 280, which may be thought of as being aligned with “true north” in the global coordinate system. As indicated at 246 in FIG. 9, the data representative of each component of structure 200 may be written to the database in memory 14 using the respective bounding box information as key. For example, each component may be defined in a data format as shown in FIG. 14, such that each bounding box is identified with a key position (e.g., the location of the local coordinate system with respect to the global coordinate system), box size, scale, translation (and rotation, if applicable), normalized spatial data (3D contents) for all points within the bounding box, and meta data associated with the respective component within the bounding box. As shown at 248 in FIG. 9, various non-spatial meta data may be associated with each respective component as described above, and each component may be linked to other existing data entries as indicated at 250.

In some embodiments, the spatial data for each component may be normalized based on the largest dimension among the points of the respective component, such that the normalized distance from the origin O_{L} of the local coordinate system to each point of such component is less than or equal to 1, for example. Of course, other normalization factors may be used, as desired, with the goal generally being to have smaller values for the spatial data in order to make storage and processing more efficient. For example, rather than having spatial data referenced in values of thousands or millions of units (e.g., inches, feet, centimeters, etc.), the spatial data may be normalized or scaled so that the values are less than or equal to 1, or within some other suitable range of values, for more efficient storage and processing. Various calculations may be made with the spatial data in the normalized format for more efficient processing, and when certain components need to be rendered on display 16, for example, the spatial data may be transformed back into the global coordinate system in order to depict each component at the proper location and orientation.

Persons of ordinary skill in the art will appreciate that the use of bounding boxes and the association of point cloud data with meta data as described herein may facilitate substantially increased functionality and processing efficiencies in various ways. For example, a system 10 as described herein may be configured to allow a user to select all bounding boxes meeting certain search criteria (e.g., those within a specified spatial volume, or those within a certain distance of a specified location, or those having meta data meeting specified criteria, such as material type, part number, last service date, or the like), and the system may render all points within those bounding boxes. Alternatively, searches may be run based on certain point criteria. Likewise, system 10 may be configured to allow a user to select any desired point in the database and view any or all meta data associated with that point (e.g., the identification of the component that point is on, the materials of which that component is made, the maintenance history of that component, and the like), without having to create mathematical computer models (e.g., CAD models) of the various components. Thus, the systems and methods described herein may be used as powerful and efficient asset management tools for structures of any size and in any industry.

The embodiments described herein are some examples of the current invention. Various modifications and changes of the current invention will be apparent to persons of ordinary skill in the art. Among other things, any feature described for one embodiment may be used in any other embodiment. The scope of the invention is defined by the attached claims and other claims to be drawn to this invention, considering the doctrine of equivalents, and is not limited to the specific examples described herein.

What is claimed is:

1. A system for generating a database representative of a physical structure having a plurality of components, comprising:
a computer;
a memory in communication with said computer; and
a laser scanner in communication with said computer;
wherein said laser scanner is configured to capture spatial data representative of points on the structure;
wherein each of said points is part of one of the plurality of components;
wherein said computer is programmed with instructions executable by said computer for
receiving said spatial data;
storing said spatial data in a database in said memory;
receiving non-spatial data representative of each of the plurality of components; and
for each of said points, associating a portion of said non-spatial data with each respective point in said database based on a respective one of the plurality of components of which each respective point is a part.

2. The system of claim 1 wherein said associating is performed without creating a model of the plurality of components.

3. The system of claim 1 wherein, for each of the plurality of components, the points that make up the respective component are compressed.

4. The system of claim 3 wherein the points that make up each respective component are compressed using a data compression scheme wherein a bounding box is used to delineate the points that make up the respective component, wherein the points that make up the respective component are defined on a row-by-row and layer-by-layer basis within the bounding box with binary data, and wherein a 1 indicates the presence of a physical point of the respective component at a given location in space and a 0 indicates the absence of a physical point at a given location in space.

5. The system of claim 1 wherein said instructions executable by said computer include instructions for:
segmenting the points into groups of points, wherein each group of points is representative of a particular one of said plurality of components;
defining a bounding box for each of said groups of points;
transforming said spatial data for each group of points from a global coordinate system into a local coordinate system associated with each respective bounding box; and
normalizing said spatial data.

6. The system of claim 5 wherein each respective local coordinate system has the same orientation as said global coordinate system.

7. The system of claim 1 further comprising a digital camera in communication with said computer;
wherein said camera is configured to capture color data representative of said points; and
wherein said computer is further programmed with instructions executable by said computer for associating said color data with said spatial data for each of said points and storing said spatial data and said color data in an associated manner in said database.

8. The system of claim 7 further comprising a display in communication with said computer, wherein said display is configured for displaying an image representative of the structure.

9. The system of claim 7 wherein each of said laser scanner and said camera is configured such that its central line of sight extending from a respective node thereof is aligned with a point H defined by a maximum effective range Rₘₐₓ of said laser scanner, and wherein said instructions comprise instructions for performing the following actions with respect to each of said points:
receiving from said laser scanner information representative of a distance from said node of said laser scanner to the respective point;
receiving from said camera information representative of color of a plurality of points on the structure, said plurality of points including the respective point;
calculating a distance d from said central line of sight of said camera to an image of the respective point within a camera image on an image plane of said camera;
identifying a pixel within said camera image located at or near said distance d from said central line of sight of said camera as corresponding to the respective point; and
associating color information of said pixel with the respective point in said database.

10. A method of generating a database of spatial and non-spatial data for a plurality of points representative of a physical structure, comprising:
receiving at a computer spatial data representative of points on a physical structure, wherein the physical structure comprises a plurality of components;
storing said spatial data in a database in a memory in communication with said computer;
receiving at said computer non-spatial data representative of each of the plurality of components; and
for each of said points, associating a portion of said non-spatial data with each respective point in said database based on a respective one of the plurality of components of which each respective point is a part.

11. The method of claim 10 further comprising:
providing a digital camera and a laser scanner in communication with said computer;
orienting each of said laser scanner and said camera such that its central line of sight extending from a respective node thereof is aligned with a point H defined by a maximum effective range Rₘₐₓ of said laser scanner;
operating said laser scanner to obtain scan information representative of a distance from said node of said laser scanner to each respective one of said plurality of points, and sending said scan information to said computer; and
for each of said plurality of points,
operating said camera to obtain image information representative of color of a set of points on the structure, said set of points including the respective one of said plurality of points, and sending said image information to said computer;
using said computer, calculating a distance d from said central line of sight of said camera to an image of the respective point within a camera image on an image plane of said camera;
using said computer, identifying a pixel within said camera image located at or near said distance d from said central line of sight of said camera as corresponding to the respective point; and
using said computer, associating color information of said pixel with the respective point in said database.

12. An article of manufacture comprising a tangible computer readable medium comprising a program having instructions executable by a computer for:
receiving at a computer spatial data representative of points on a physical structure, wherein the physical structure comprises a plurality of components;
storing said spatial data in a database in a memory in communication with said computer;
receiving at said computer non-spatial data representative of each of the plurality of components; and
for each of said points, associating a portion of said non-spatial data with each respective point in said database based on a respective one of the plurality of components of which each respective point is a part.

13. The article of claim 12 wherein said instructions further comprise instructions for:
segmenting the points into groups of points, wherein each group of points is representative of a particular one of said plurality of components;
defining a bounding box for each of said groups of points;
transforming said spatial data for each group of points from a global coordinate system into a local coordinate system associated with each respective bounding box; and
normalizing said spatial data.

14. The article of claim 13 wherein said instructions further comprise instructions for:
selecting all of said bounding boxes that meet certain search criteria (hereafter, selected bounding boxes); and
rendering all of said points that are within said selected bounding boxes.

15. The article of claim 13 wherein said instructions further comprise instructions for:
selecting any one of said points (hereafter, a selected point); and
viewing any or all of said non-spatial data associated with said selected point.
